(19) United States
(12) Patent Application Publication
(10) Pub. No.: US 2007/0275761 A1
(43) Pub. Date: Nov. 29, 2007

(54) Dynamic cell control through antenna radiation pattern synthesis

(75) Inventors: Hang Jin, Plano, TX (US); John Grabner, Plano, TX (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(73) Assignee: Navini Networks, Inc.

(21) Appl. No.: 11/705,239

(22) Filed: Feb. 12, 2007

Related U.S. Application Data
(60) Provisional application No. 60/808,318, filed on May 24, 2006.

(51) Int. Cl. H04M 1/00

(52) U.S. Cl. 455/562.1

(57) ABSTRACT

A method for cell control in a wireless network is disclosed, which comprises providing a base transceiver station (BTS) with a plurality of antennas receiving a plurality of feed signals, respectively, varying one or more parameters of the plurality of feed signals according to a plurality of predetermined criteria for synthesizing a desired antenna radiation pattern, wherein a coverage area of the BTS is adjusted.

### RELATE BACK

The present invention claims priority to U.S. Provisional application 60/808,318 filed May 24, 2006.

### BACKGROUND

The present invention relates generally to wireless communication systems, and more particularly to dynamic cell control.

Cell control, i.e., cell blossoming, cell wilting or cell breathing, is a process with which the cell coverage is deliberately tweaked during operations. Cell control is one of the key network optimization processes aiming to improve network performances. For example, a cell wilting is a network gradually reduces a cell's coverage to take it out of service for maintenance without causing dropped calls. Cell blossom is adding a new cell into the network by gradually increasing its coverage without overloading active terminals. Cell breathing is used to dynamically shuffle users among cells to help better balance traffics among the cells.

A conventional cell control method employs forward power control. For example, given a total power allocated for a round of traffic, the coverage radian can be estimated based on a path loss, which, in turn, is mainly determined by following factors: base transceiver station (BTS) height, carrier frequency, morphology of the coverage area, and terminal heights. If the coverage needs be reduced (cell wilting or breathe), the network may reduce the power allocated for the traffic. The amount of power reduction can be estimated from the relationship of transmitter power vs. coverage radian. The transmitter power vs. coverage radian relationship can be established theoretically or experimentally. The cell control via forward power control needs be carried out synchronically among multiple cells in a cluster to avoid leaving coverage holes in the coverage area. This makes the network system design complicated

Therefore, what is desired is simple cell control method that can be carried out dynamically and in real time.

### SUMMARY

In view of the foregoing, the present invention discloses a new method for cell control in a wireless network. In one aspect of the present invention, the method comprises providing a base transceiver station (BTS) with a plurality of antennas receiving a plurality of feed signals, respectively, varying one or more parameters of the plurality of feed signals according to a plurality of predetermined criteria for synthesizing a desired antenna radiation pattern, wherein a coverage area of the BTS is adjusted.

In another aspect of the present invention, the method comprises providing a base transceiver station (BTS) with a plurality of antennas consecutively receiving a first and second plurality of feed signals, respectively, varying one or more parameters of the first plurality of feed signals according to a first plurality of predetermined criteria for synthesizing a first desired antenna radiation pattern, and varying one or more parameters of the second plurality of feed signals according to a second plurality of predetermined criteria for synthesizing a second desired antenna radiation pattern, wherein the first and second desired antenna radiation patterns covers a first and second areas either next to or substantially overlap each other.

The construction and method of operation of the invention, however, together with additional objects and advantages thereof will be best understood from the following description of specific embodiments when read in connection with the accompanying drawings.

### BRIEF DESCRIPTION OF THE DRAWINGS

The present invention is illustrated by way of example, and not by way of limitation, in the figures of the accompanying drawings in which like reference numerals refer to similar elements.

FIG. 1 illustrates conventional cells with omni-directional coverage area in a wireless network.

FIGS. 2A and 2B illustrate cells with antenna radiation pattern synthesis in a wireless network according to an embodiment of the present invention.

FIG. 3 is a flow chart illustrating steps taken to synthesize antenna radiation patterns according to the embodiment of the present invention.

### DESCRIPTION

The following will provide a detailed description of a cell control method that controls cells' coverage though real-time antenna radiation pattern synthesis, which allows for two-dimensional cell coverage control and improves system performances. This method can be used alone or combined with the conventional cell control method of varying BTS transmitter power.

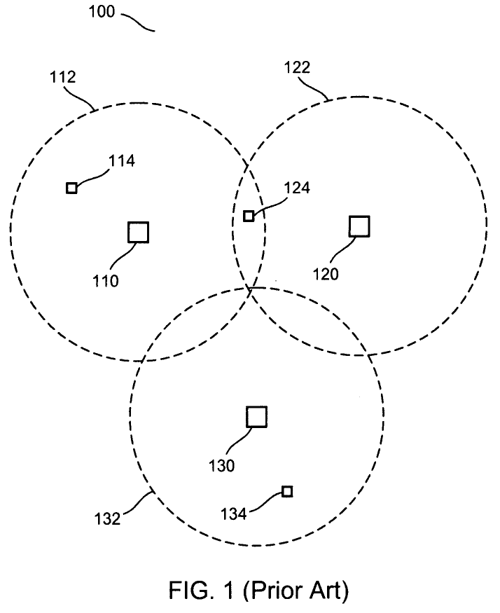

FIG. 1 illustrates conventional cells with omni-directional coverage area in a wireless network 100. Base transceiver stations (BTSs) 110, 120 and 130 cover omni-directional areas 112, 122 and 132, respectively. Terminals 114 and 134 are in the omni-directional areas 112 and 132, respectively, and therefore served by the BTSs 110 and 130, respectively. A terminal 124 is in an overlapping area of the omni-directional areas 112 and 122, and therefore can be served by both BTSs 110 and 120. For the wireless network 100 with conventional omni-directional cells, cell control may be achieved through varying forward transmission power. But the shape of the coverage areas 112, 122 and 132 are always circular. Varying forward transmission power results only in diameter changes of the circular coverage areas 112, 122 and 132. When neighboring cells require different coverage areas, diameter change is apparently less efficient to have all the areas covered.

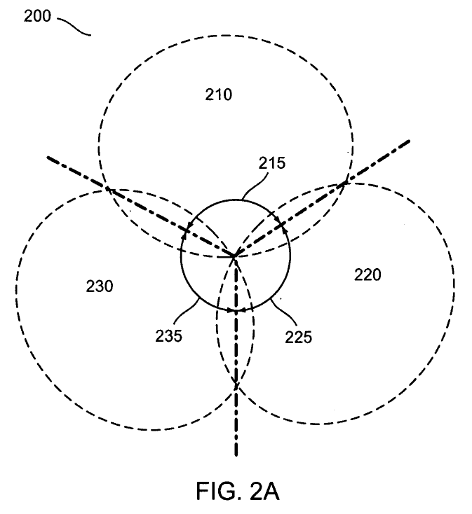

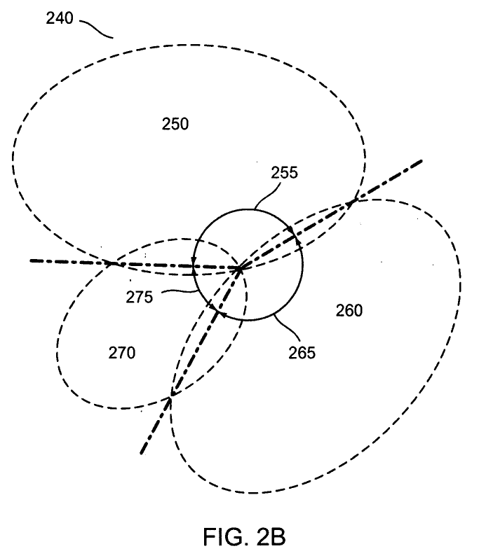

FIGS. 2A and 2B illustrate cells with antenna radiation pattern synthesis in a wireless network 200 according to an embodiment of the present invention. Referring to FIG. 2A, cell coverage areas 210, 220 and 230 are provided by corresponding BTSs (not shown), respectively, through antenna radiation pattern synthesis. Angle spans 215, 225 and 235 represent the radiation pattern spanning of the coverage areas 210, 220 and 230, respectively. Assuming each coverage area 210, 220 or 230 has approximately equal amount of traffic loads, then the radiation patterns span an equal 120° in an azimuth plane, i.e., the three coverage areas 210, 220 and 230 are approximately equal in shape and size.

Referring to FIG. 2B, coverage areas 250, 260 and 270 in a wireless network 240 are of different sizes. Angle spans 255, 265 and 275 represent radiation pattern spanning of the coverage areas 250, 260 and 270, respectively. Angle spans 255 and 265 are equally at 150°, and angle span 275 is at 60°. Therefore, the coverage area 330 is significantly smaller than the coverage areas 250 and 260. In this case, traffic density in coverage area 270 is higher than in other two coverage areas 250 and 260. That is when the coverage area 270 is overloaded with traffic while other two coverage areas 250 and 260 are underloaded; the angle span 275 of the overloaded coverage area 270 is reduced, while the angle spans 255 and 265 of the other coverage areas 250 and 260, respectively, are increased. As a result, some of the terminals that previously belong to the overloaded coverage area 270 are now being shuffled to the underloaded coverage areas 250 and 260. This will balance out the traffic loads among the three coverage areas 250, 260 and 270. Apparently adjusting the shapes and sizes of cell coverage areas through antenna radiation pattern synthesis is more efficient than adjusting diameters of circular cell coverage areas shown in FIG. 1.

Antenna radiation pattern synthesis is more achievable in a BTS with multiple antennas. For a BTS with an antenna array, traffics are received and sent through beamformings. For all uplink traffics (data sent from terminals to the BTS), the BTS antenna array will beamform them via either maximum ratio combining (MRC) or equal gain combining (EGC), or log likely-hood (LLC) combining or any other combining schemes. For downlink traffics, there are two types of beamformings. For traffic that is intended for a particular terminal, BTS will beamform the traffic to that particular terminal. However, for traffics that are intended for a group of terminals over a large coverage area, or the traffics are intended for a particular terminal but the terminal is not fixed and may be at any locations over a large coverage area (uncertainty of its spatial signature), BTS needs to send the traffic to a large designated coverage area. This can be achieved by synthesizing a radiation pattern that covers the desired area. For example, as shown in FIG. 1, if the desired coverage area is a circle with the BTS in the center, the synthesized BTS antenna radiation pattern for broadcast messages will be an omni-directional.

In order to synthesize a BTS's radiation pattern to a desired shape and size, parameters such as magnitudes and phases of the BTS's feed signals need to be set in such a way that the difference between the resulted (synthesized) pattern and a desired radiation pattern is minimized. For example, for a circular array with λ/2 spacing, where λ is a wave length of the signal, an omni-directional radiation pattern can be achieved by setting the same magnitude and phase for all feed signals. For a linear array with 8 elements and λ/2 spacing, a radiation pattern spanning 120° in the azimuth plane, as shown in FIG. 2A, can be achieved with the feed signals that have the same magnitude but different phases as follows:

Phase=[−312°, −208°, −52°, 0°, 0°, −52°, −208°, −312°].

For the same linear array, a radiation pattern spanning 40° in the azimuth plane, as shown in FIG. 2B, can be achieved with the feed signals that have the same magnitude and the following phases:

Phase=[135°, 100°, 30°, 0°, 0°, 30°, 100°, 135°].

Although synthesizing only two spanning angles through phase adjustments are disclosed here, one having skill in the art would have no difficulties to synthesizing other spanning angles through different phases adjustments as well as magnitude adjustments.

The antenna radiation pattern synthesis follows the general practice of optimization procedure, and all techniques used in optimization can be readily used here. A difference is that the optimization objective is the desired radiation pattern. In addition, some optimization constraints may also be added. For example, it may be required that all antennas have the same output power. This would make the feed signals for all antennas have the same magnitude. Another example of adding constraints is that the gain ripple of the synthesized pattern needs be less than certain threshold.

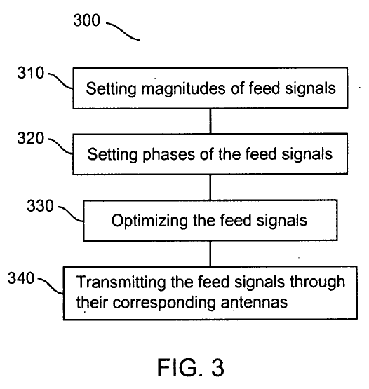

FIG. 3 is a flow chart 300 illustrating steps taken to synthesize antenna radiation patterns in more generic terms according to the embodiment of the present invention. In order to synthesize a desired antenna radiation pattern by a multi-antenna BTS, the BTS first sets magnitudes of feed signals based on prior knowledge in step 310. Then it is followed by phase setting on the feed signals also according to prior knowledge in step 320. These feed signals may be optimized, such as adding output power constraints, in step 330. Finally the adjusted feed signals are transmitted through their corresponding antennas in step 340. Note that the magnitudes and phases of the feed signals of each antenna element can be set in a baseband, radio frequency (RF) or a combination of the both.

The antenna radiation pattern synthesis method may be combined with the forward power control method to control cell coverage areas. Forward power allocation determines the coverage along radian while the antenna radiation pattern determines the coverage in the angular dimension. With the forward power control and antenna radiation synthesis, cell coverage area may be shaped the in two dimensions. This will considerably improve the cell control.

There are many applications of the dynamic cell control. Some of them are described below. A first application is traffic balances. The dynamic traffic control is used to better balance the traffics among cells. The cell control needs to be dynamic and in real time. The traffics are monitored for all cells, and if unbalanced traffics are detected, the over loaded cell will reduce its cell coverage along radian or angular or both, and the under loaded cells will increase its cell coverage along radian or angular or both. The coverage change along radian is done through power control, while the coverage change along angular is done through radiation pattern synthesis.

A second application is cell wilt. The cell control can be used to wilt cells out for the purpose of maintenance or repair.

A third application is cell blossom. The cell control can be used to add new cells into the network.

A fourth application is network planning. The antenna radiation pattern synthesis can help to improve the cell planning. After an initial cell planning and testing, some coverage holes in the coverage area may be discovered. The coverage holes can be covered up by tweaking the radiation patterns through antenna radiation pattern synthesis.

A fifth application is cell splitting. The cell control can be used for the purpose of dynamic cell splitting. Dynamic cell splitting is done through antenna radiation pattern synthesis. For example, if the cell needs to be split into two virtual smaller cells, one could synthesize a radiation pattern that has two distinctive beams (split pattern) that their aggregated beam pattern covers the original coverage area. Each beam covers a sub-region of the original coverage area. The resource assigned for these two sub-regions could be the same or different. Splitting cells via split radiation beams is a technique used to improve frequency reuse within cell and among cells. For example, if a 120° cell is split into two 60° cells, the same spectrum can be used twice within the cell, one for terminals in one beam, and the other for terminals in the other beam. The cell splitting is dynamic and in real time, varying with time and traffic condition.

A sixth application is diversity. The antenna radiation pattern synthesis can be used for the purpose of diversity. For example, a BTS synthesizes two radiation patterns that are different in spatial characteristics (like different DOA) and send and receive the same messages via both the radiation patterns. In a case of fading channel, one copy of the message may be faded out. But chances that the two copies of the messages are faded out at the same time are small, so a terminal has a better chance to detect one good copy of the message.

A seventh application is antenna reuse and carrier overlay. With the antenna radiation pattern synthesis, it is possible to use the same set of antennas for multiple coverage areas. For example, an initial 120° coverage area is running out its capacity, and the wireless network needs to overlay the initial cell with another carrier. One way to do this is to synthesize a 60° antenna radiation pattern for the initial carrier and a 60° radiation pattern for the new carrier. These two 60° radiation patterns have their bore sights separated by 60° and cover the original 120° coverage area. Benefits of antenna radiation pattern synthesis in this case include that the same antennas are reused, and since the two carriers are not overlapped in space, there will be less hand off between these two carriers, resulting in better overall performance.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for cell control in a wireless network, the method comprising:
providing a first base transceiver station (BTS) with a first plurality of antennas receiving a first plurality of feed signals, respectively; and
varying a first plurality of parameters of the first plurality of feed signals according to a first plurality of predetermined criteria for synthesizing a first antenna radiation pattern,
wherein a first coverage area of the first BTS covered by the first antenna radiation pattern is adjusted.

2. The method of claim 1, wherein the first plurality of parameters includes magnitudes and phases of the first plurality of feed signals.

3. The method of claim 2 further comprising setting the first plurality of feed signals to the same predetermined magnitude.

4. The method of claim 1 further comprising setting a gain ripple of the first antenna radiation pattern to be less than a predetermined threshold.

5. The method of claim 1, wherein varying the first plurality of parameters occurs while the first plurality of feed signals are in a baseband.

6. The method of claim 1, wherein varying the first plurality of parameters occurs while the first plurality of feed signals are in radio frequencies.

7. The method of claim 1, wherein varying the first plurality of parameters occurs while a first group of the first plurality of feed signals are in a baseband and a second group of the first plurality of feed signals are in radio frequencies.

8. The method of claim 1 further comprising:
monitoring a traffic load in the first coverage area; and
varying the parameters of the first plurality of feed signals based on the traffic load,
wherein the coverage area of the first antenna radiation pattern shrinks when the traffic is overloaded, and the coverage area of the first antenna radiation pattern expands when the traffic is under-loaded.

9. The method of claim 1 further comprising varying a transmitter power of the first BTS.

10. The method of claim 9 further comprising diminishing the first plurality of feed signals through the varying the first plurality of parameters and the varying transmitter power, wherein a cell covered by the first BTS is wilted out.

11. The method of claim 9 further comprising blossoming the first plurality of feed signals through the varying the first plurality of parameters and the varying transmitter power, wherein a new cell is added.

12. The method of claim 1 further comprising:
detecting one or more coverage holes in the first coverage area; and
specifying the first plurality of predetermined criteria,
wherein the coverage holes are covered after varying the one or more parameters of the first plurality of feed signals according to the first plurality of predetermined criteria.

13. The method of claim 1, wherein the first antenna radiation pattern includes two or more sub-regions formed by two or more radiation patterns, respectively, which are synthesized by the first plurality of feed signals.

14. The method of claim 1 further comprising:
receiving a second plurality of feed signals by the first plurality of antennas; and
varying a second plurality of parameters of the second plurality of feed signals according to a second plurality of predetermined criteria for synthesizing a second antenna radiation pattern,
wherein the first and second antenna radiation patterns cover substantially the same area and a message is transmitted via both the first and second radiation patterns.

15. The method of claim 1 further comprising:
providing a second BTS with a second plurality of antennas receiving a second plurality of feed signals, respectively; and
varying a second plurality of parameters of the second plurality of feed signals according to a second plurality of predetermined criteria for synthesizing a second antenna radiation pattern,
wherein coverage areas of the first and second antenna radiation patterns are adjusted to substantially next to each other.

16. A method for cell control in a wireless network, the method comprising:
providing a base transceiver station (BTS) with a plurality of antennas consecutively receiving a first and second plurality of feed signals, respectively;
varying a first plurality of parameters of the first plurality of feed signals according to a first plurality of predetermined criteria for synthesizing a first antenna radiation patterns; and
varying a second plurality of parameters of the second plurality of feed signals according to a second plurality of predetermined criteria for synthesizing a second antenna radiation patterns,
wherein a first and second coverage areas of the BTS covered by the first and second antenna radiation patterns, respectively, are adjusted.

17. The method of claim 16, wherein
the first plurality of parameters include magnitudes and phases of the first plurality of feed signals; and
the second plurality of parameters includes magnitudes and phases of the second plurality of feed signals.

18. The method of claim 16, wherein the first and second coverage areas are next to each other for cell splitting.

19. The method of claim 16, wherein the first and second coverage areas substantially overlap each other, wherein a message is transmitted via both the first and second radiation patterns.

20. A method for cell control in a wireless network, the method comprising:
providing a base transceiver station (BTS) with a plurality of antennas receiving a plurality of feed signals, respectively, for covering a cell coverage area;
monitoring a traffic load in the cell coverage area; and
varying one or more parameters of the plurality of feed signals for synthesizing an antenna radiation pattern covering the cell coverage area,
wherein the cell coverage area shrinks when the traffic is overloaded and the first coverage area expands when the traffic is under-loaded.

21. The method of claim 20, wherein the plurality of parameters includes magnitudes and phases of the plurality of feed signals.

22. The method of claim 20 further comprising setting a gain ripple of the antenna radiation pattern to be less than a predetermined threshold.

23. The method of claim 20, wherein varying the first plurality of parameters occurs while the plurality of feed signals are in a baseband.

24. The method of claim 20, wherein varying the plurality of parameters occurs while the plurality of feed signals are in radio frequencies.

25. The method of claim 20, wherein varying the plurality of parameters occurs while a first group of the plurality of feed signals are in a baseband and a second group of the plurality of feed signals are in radio frequencies.

26. The method of claim 20 further comprising varying a transmitter power of the BTS.
